(19) United States
(12) Patent Application Publication
(10) Pub. No.: US 2004/0189321 A1
(43) Pub. Date: Sep. 30, 2004

(54) Fiber optic MT ferrule connector

(76) Inventors: Gregory M. Drexler, Minnetonka, MN (US); Mark E. Nelson, Farmington, MN (US)

Correspondence Address: Glenn W. Bowen, Lockheed Martin Corporation, 3333 Pilot Knob Road, Eagan, MN, 55121, US

(21) Appl. No.: 10/397,464

(22) Filed: Mar. 26, 2003

(51) Int. Cl. H01H 31/04

(52) U.S. Cl. 324/538

(57) ABSTRACT

Two connector components, such as MT ferrules are secured in a three part holding device for testing purposes. One of the connector components is located in cavities formed in two of the parts of the holding device and the other connector component is located in a cavity formed in the third part of the holding device. Fasteners hold the three pieces together and alignment between the pieces is provided by pin and bore provisions.

### CROSS-REFERENCE TO RELATED APPLICATIONS

Not applicable.

### STATEMENT REGARDING FEDERALLY SPONSORED RESEARCH

Not applicable.

### REFERENCE TO A “MICROFICHE APPENDIX”

Not applicable.

### BACKGROUND OF THE INVENTION

1. Technical Field

This invention is related to assemblies that allow for the testing of optical connector components in a reliable, safe manner prior to final assembly of optical connectors into a system. More particularly, the invention relates to a fixture that temporarily holds the optical components so they may be easily assembled and removed during testing.

2. Background Information

As the use of fiber optical systems expands, the need for testing optical connections also increases. Currently optical connector components, for example MT ferrules, are couple together by spring clips, such as the clip 2 shown in prior art FIG. 1 which is supplied by USConec. The legs 4 and 6 are spread apart and each leg is forced over the side of one of the ferrules that is remote from the fiber connection of each ferrule. This arrangement results in slow and awkward assembly and removal of the connectors. It is also susceptible to causing damage to the optical components. The present invention provides a fixture that allows for the temporary testing of optical connector components in a reliable, efficient manner.

### BRIEF SUMMARY OF THE INVENTION

A fixture for temporarily holding a pair of optical MT ferrules in alignment for testing purposes is constructed with three holding elements each having a holding cavity. Two of these cavities conform to the shape of one connector component of the optical connector, and the other of which conforms to the shape of the other connector component. The holding elements. are aligned with alignment pins and corresponding alignment bores. The two holding elements that conform to the shape of one connector component are secured together by a pair of fastening elements, and one of these two holding elements is secured to the third holding element by at least one fastening element.

### BRIEF DESCRIPTION OF THE SEVERAL VIEWS OF THE DRAWINGS

The invention is described by reference to the drawings in which:

FIG. 1 is a side view of a prior art clip that is used to hold two optical MT ferrules,

FIG. 2 is a perspective view of a prior art pin assembly for aligning two optical ferrules, and

FIG. 3 is an exploded perspective view of the fixture of the present invention.

### DETAILED DESCRIPTION OF THE INVENTION

The invention provides a fixture that allows for fast, reliable connections between fiber optical connectors which is especially useful for the testing of optical connectors, such as the common MT type of optical connector. The fixture enables MT ferrules to be temporarily connected prior to assembly of them in connectors for their final application. After optical connectors have been assembled they can be very difficult to repair if one of them is defective. However, MT ferrules, for example, do not form a complete connector but they can be easily mated to another MT ferrule for testing.

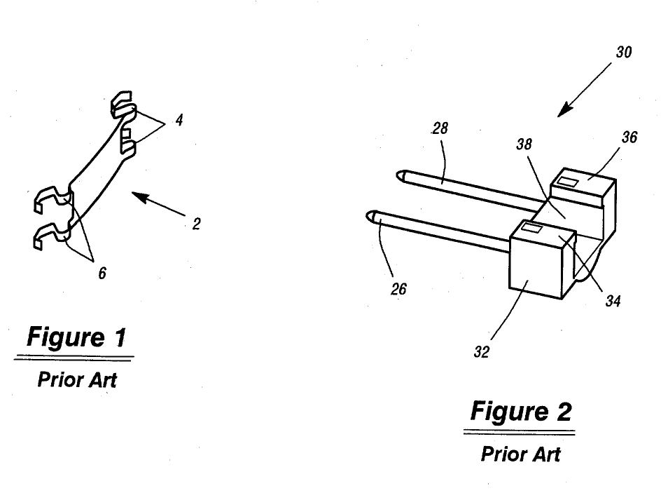

MT optical ferrules have been tested previously by temporarily coupling two ferrules together with simple metal spring clips, as shown in prior art FIG. 1, that merely clip on the ends of each of the ferrules and force them together. USConec Ltd. of Hickory, N.C. sells optical ferrules and spring clips for this purpose. While these spring clips can be used for functional testing they are not easily installed or removed. The ferrules are not held in a fixed mounting by the spring clip and this increases the possibility of damage during testing unless a special mounting is also provided. The present invention allows for easy insertion and removal of the ferrules in the fixture and also protects them against damage during testing.

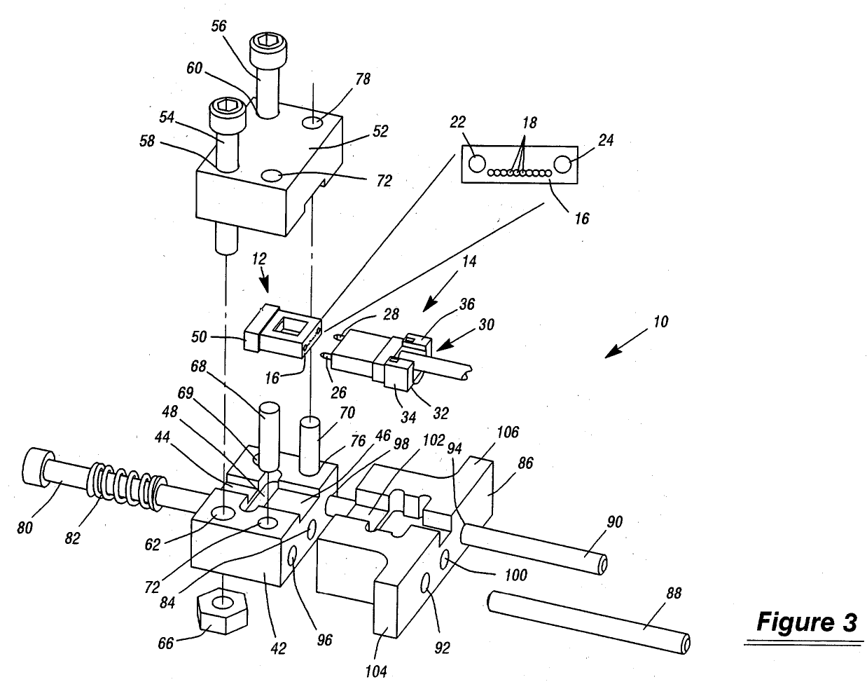

FIG. 3 shows a fixture 10 constructed in accordance with the invention to hold the two ferrules 12 and 14 that are to be mated together. The ferrule 12 has a front face 16 that has a number of optical ports 18 that are aligned with a corresponding number of optical ports, (not shown), in the front face 20 of the ferrule 14. The ferrule 12 has a pair of alignment holes 22, 24 that respectively receive the pins 26, 28 that are associated with the ferrule 14. The pins 26, 28 are part of a pin assembly 30, (shown in FIG. 2),that has a body 32 into which the pins 26, 28 are secured. The prior art pin assembly has two wings 34, 36 and a recessed center portion 38 that allows the assembly to be slipped onto the ferrule 14 to allow the two ferrules to be coupled together. The spring clip 40 was in the past then clipped onto the rear surfaces of the ferrules 12, 14 to hold them together. This assembly was then held in place with the aid of a clamping tool.

The invention replaces the spring clip 20 to provide for easier insertion and removal and more protection during testing by placing the ferrules 12, 14 into the fixture 10. The fixture 10 consists of a first block 42 that has a cavity 44 that is shaped to receive the ferrule 12. The block 42 has an elongated recess 48 which receives the body of the ferrule 12 and a deeper cross-wise recess 48 that receives the rim 50 of the ferrule 12. An upper block 52 fits over the top of the ferrule 12 and it has elongated and cross-wise recesses that are matched to the corresponding recesses in block 42.

The blocks 42 and 52 are secured together by the bolts 54, 56 which pass through the holes 58, 60, respectively, in block 52 and the holes 62, 69, respectively, in block 42. The bolts are screwed into threaded fasteners, such as the nut 66. Guide pin 68 is inserted into the hole72 in block 42 and the hole72 in block 52, while guide pin 70 is inserted into the hole76 in block 42 and the hole78 in block 52. A bolt 80 is inserted axially into a coil spring 82 and into a hole 84 that runs through the block 42.

Another block 86 is provided which receives the ferrule 14. This block receives two alignment pins 88, 90 that extend through holes 92, 94, respectively, in block 86 that are press fit into the holes 96, 98 when block 86 is pushed into engagement with block 42. The hole 100 in block 86 is threaded and allows for the bolt 80 to be screwed into it while compressing the spring 82 to provide a return force upon release. The block 86 has a recess 102 to receive the body of the ferrule 14 and the pin assembly 30. The lips 104, 106 provide surfaces that can be used to push the block 86 toward and away from the block 42.

What is claimed is:

1. A fixture for holding first and second connector components in coupled alignment, comprising;
(a) a first holding element comprising a first holding cavity that conforms to at least a portion of the shape of said first connector component wherein said first holding cavity receives said first connector component therein,
(b) a second holding element comprising a second holding cavity that conforms to at least a portion of the shape of said second connector component wherein said second holding cavity receives said second connector component therein,
(c) a third holding element comprising a third holding cavity that conforms to at least a portion of the shape of said second connector component that is not received by said second holding element wherein said first and second cavities substantially encompass said second connector component,
(d) a pair of first and second fastening elements coupled to said second and third elements for securing said second and third holding elements together, and
(e) at least one third fastening element coupled to one of said second and third holding elements and to said first holding element for securing said one of said second and third holding elements and said first holding element together.

2). A fixture as claimed in claim 1, comprising; at least one pair of alignment pins and matching alignment bores, wherein each of said alignment bores receives one of said alignment pins, and each of said alignment bores is located in one of said holding elements.

3). A fixture as claimed in claim 1, comprising; at least one pair of alignment pins and matching alignment bores, wherein each of said alignment bores receives one of said alignment pins, and each of said alignment bores is located in one of said second or third holding elements or in said first holding element.

4). A fixture as claimed in claim 1 wherein said connector components consist of a pair of optical MT ferrules.

5). A fixture as claimed in claim 1 wherein said at least one of said third fastening elements comprises a threaded bore in said first holding element, a second bore in one of said second and third holding elements, a threaded screw having a shaft with threads thereon which extend through said second bore and are screwed into said threaded bore and a head thereon, and a coil spring that surrounds said shaft and is positioned between said head of said threaded screw and one of said. second and third holding elements that has said second bore therein.
